(19) United States
(12) Patent Application Publication
(10) Pub. No.: US 2023/0259134 A1
(43) Pub. Date: Aug. 17, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: KEISUKE MAEDA, TOKYO (JP)

(21) Appl. No.: 18/005,144

(22) PCT Filed: Jul. 7, 2021
(86) PCT No.: PCT/JP2021/025621

§ 371 Date: Jan. 11, 2023

(30) Foreign Application Priority Data
Jul. 21, 2020 (JP) 2020-124193

(51) Int. Cl. G05D 1/02

(52) U.S. Cl. CPC G05D 1/0212; G05D 1/0287; B64U 10/00

(57) ABSTRACT

The present technology relates to an information processing device, an information processing method, and a program that enable a mobile device to flexibly correspond to a designated action target. A movement target of the mobile device is calculated on the basis of action target information indicating an action target designating a movement destination of the mobile device and movable space information indicating a movable space which is a range of a real space in which the mobile device is movable.

### TECHNICAL FIELD

The present technology relates to an information processing device, an information processing method, and a program, and particularly relates to an information processing device, an information processing method, and a program that enable a mobile device to flexibly correspond to a designated action target.

### BACKGROUND ART

Patent Document 1 discloses a technique for efficiently moving an autonomous mobile robot to a destination point given by a user.

### CITATION LIST

### Patent Document

Patent Document 1: Japanese Patent Application Laid-Open No. 2006-195969

### SUMMARY OF THE INVENTION

### Problems to be Solved by the Invention

In a case where an action target such as movement to a destination point is designated to a mobile device such as an autonomous mobile robot, there have been cases where the mobile device is not able to cope with the designated action target depending on the capability (performance/function) of the mobile device, the state of a moving space, and the like.

The present technology has been made in view of such a situation, and enables a mobile device to flexibly cope with a designated action target.

### Solutions to Problems

An information processing device or a program of the present technology is an information processing device including a target planning unit that calculates a movement target of a mobile device on the basis of action target information indicating an action target that designates a movement destination of the mobile device and movable space information indicating a movable space that is a range of a real space in which the mobile device is movable, or a program for causing a computer to function as such an information processing device.

An information processing method of the present technology is an information processing method including, by a target planning unit of an information processing device that includes the target planning unit, the information processing method including, by the target planning unit, calculating a movement target of a mobile device on the basis of action target information indicating an action target that designates a movement destination of the mobile device and movable space information indicating a movable space that is a range of a real space in which the mobile device is movable.

In the present technology, a movement target of the mobile device is calculated on the basis of action target information indicating an action target designating a movement destination of the mobile device and movable space information indicating a movable space which is a range of a real space in which the mobile device is movable.

### BRIEF DESCRIPTION OF DRAWINGS

FIG. 1 is a block diagram illustrating a configuration of a first embodiment of an autonomous mobile body control system to which the present technology is applied.

FIG. 2 is a block diagram illustrating a configuration of a target planning unit and a storage unit.

FIG. 3 is a diagram illustrating a list of information supplied to the target planning unit and information calculated by the target planning unit.

FIG. 4 is a diagram illustrating a flow of information of the autonomous mobile body control system.

FIG. 5 is a flowchart illustrating a processing procedure performed by the autonomous mobile body control system.

FIG. 6 is a diagram illustrating an operation of the autonomous mobile body of a comparative example with respect to an example of an action purpose and an action target.

FIG. 7 is a diagram illustrating an operation of the autonomous mobile body in a first mode with respect to an action purpose and an action target similar to those in FIG. 6.

FIG. 8 is a diagram illustrating an operation of the autonomous mobile body of a comparative example with respect to an example of the action purpose and the action target.

FIG. 9 is a diagram illustrating an operation of the autonomous mobile body of the first present embodiment with respect to an action purpose and an action target similar to those in FIG. 8.

FIG. 10 is a block diagram illustrating a configuration of a second embodiment of an autonomous mobile body control system to which the present technology is applied.

FIG. 11 is a diagram illustrating a flow of information of the autonomous mobile body control system in FIG. 10.

FIG. 12 is a flowchart illustrating a processing procedure performed by the autonomous mobile body control system in FIG. 10.

FIG. 13 is a diagram illustrating operations of the autonomous mobile body of the second embodiment with respect to an example of an action purpose and an action target.

FIG. 14 is a block diagram illustrating a configuration example of hardware of a computer that executes a series of processes by a program.

### MODE FOR CARRYING OUT THE INVENTION

Hereinafter, embodiments of the present technology will be described with reference to the drawings.

<<Autonomous Mobile Body Control System to Which Present Technology is Applied>>

<Configuration of First Embodiment of Autonomous Mobile Body Control System to Which Present Technology is Applied>

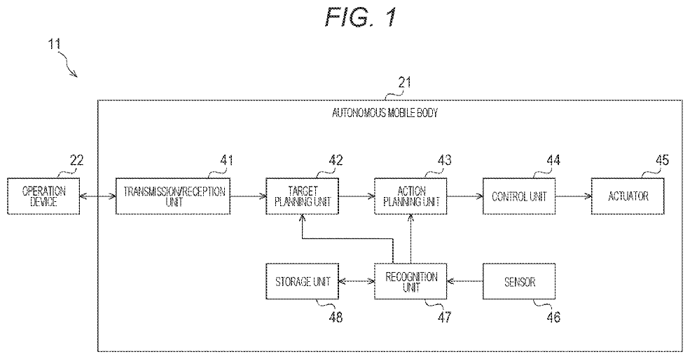

FIG. 1 is a block diagram illustrating a configuration of a first embodiment of an autonomous mobile body control system to which the present technology is applied.

In FIG. 1, an autonomous mobile body control system 11 which is a first embodiment of an autonomous mobile body control system to which the present technology is applied includes an autonomous mobile body 21 (mobile device) and an operation device 22. Note that the boundary between the autonomous mobile body 21 and the operation device 22 is not limited to the case of FIG. 1. Some of the components of the autonomous mobile body 21 in FIG. 1 may be included in the operation device 22, and some or all of the components of the operation device 22 may be included in the autonomous mobile body 21.

The autonomous mobile body 21 is a mobile device that moves by an arbitrary moving method. For example, the autonomous mobile body 21 may be a vehicle type, a flying type, a multileg type, or an endless track type mobile device. The autonomous mobile body 21 executes an action such as movement or image-capturing on the basis of action purpose information and action target information supplied from the operation device 22. The action purpose information indicates an action purpose of what the autonomous mobile body 21 performs. The action purpose includes, for example, any one or more of movement, approach, and image-capturing.

The action target information indicates an action target that limits (specifies/designates) the movement destination of the autonomous mobile body 21 with respect to the action purpose. The action target includes, for example, any one or more of a position, a posture, or an object.

The operation device 22 is any device for a user to perform an input operation. The operation device 22 may be, for example, a personal computer, a smartphone, a tablet, or the like. Furthermore, for example, the operation device 22 is connected to the autonomous mobile body 21 so as to be wirelessly communicable with the autonomous mobile body. Communication between the operation device 22 and the autonomous mobile body 21 may be via a network such as the Internet, and is not limited to a specific communication method as long as information can be exchanged.

The operation device 22 receives the action purpose information and the action target information of the autonomous mobile body 21 that are input by operation by the user, and supplies the action purpose information and the action target information designated by the user to the autonomous mobile body 21 by communication. Note that the action purpose information and the action target information may be supplied from a system other than the operation device 22 operated and input by the user, and are not limited to a case where the user designates the action purpose information and the action target information. However, in the following description, it is assumed that the user designates the action purpose information and the action target information.

(Configuration of Autonomous Mobile Body 21)

The autonomous mobile body 21 includes a transmission-reception unit 41, a target planning unit 42, an action planning unit 43, a control unit 44, an actuator 45, a sensor 46, a recognition unit 47, and a storage unit 48.

The transmission-reception unit 41 controls communication with the operation device 22. The transmission-reception unit 41 acquires the action purpose information and the action target information designated by the user from the operation device 22 by communication. The transmission-reception unit 41 supplies the acquired action purpose information and action target information to the target planning unit 42.

The target planning unit 42 calculates a movement target (reachable target) that is reachable by the autonomous mobile body 21 on the basis of the action purpose information and the action target information designated by the user. The reachable target is a position/posture of a target to which the autonomous mobile body 21 should move, and represents a movement target limited within a range of a real space in which the autonomous mobile body 21 is movable. Note that the position/posture represents a position, a posture, or a position and a posture. The movement target may be not only one position/posture but also a plurality of positions/postures.

When calculating the reachable target, the target planning unit 42 refers to movable space information and the like supplied from the recognition unit 47.

The target planning unit 42 supplies the calculated reachable target to the action planning unit 43.

On the basis of the reachable target from the target planning unit 42, the action planning unit 43 calculates an action plan including a track and the like until the autonomous mobile body 21 that is the host device reaches the reachable target. The action plan includes information regarding an action corresponding to the action purpose indicated by the action purpose information in addition to the information regarding movement.

The track of the action plan includes, for example, information of the position/posture (arrival point) of the reachable target and information of one or more passing points until the autonomous mobile body 21 reaches the reachable target from the current position/posture. When calculating the action plan, the action planning unit 43 refers to the information of the current position/posture of the autonomous mobile body 21, the movable space information, and the like supplied from the recognition unit 47. The movable space information is information indicating a range of a space in which the host device is movable.

The action planning unit 43 supplies the calculated action plan (track) to the control unit 44.

The control unit 44 supplies a control signal (control value) to the actuator 45 on the basis of the action plan from the action planning unit 43. The control unit 44 controls the actuator 45 by the control signal (control value) to move the autonomous mobile body 21 according to the action plan (track or the like) from the action planning unit 43.

The actuator 45 operates a moving mechanism (wheels, propellers, caterpillars, or the like) for moving the autonomous mobile body 21 to move the autonomous mobile body 21. The actuator 45 is not limited to a specific type.

The sensor 46 includes a sensor that detects the position/posture of the autonomous mobile body 21, a sensor that detects space information, and the like. For example, the sensor 46 may include a camera (imaging device), a laser sensor (distance measuring sensor), an inertial measurement unit (IMU), and the like. The type of the camera may be a monocular camera, a compound eye camera, a depth camera, a ToF camera, or the like.

The sensor 46 may be a sensor used for simultaneous localization and mapping (SLAM) technology.

The sensor data detected by the sensor 46 is supplied to the recognition unit 47.

On the basis of the sensor data from the sensor 46, the recognition unit 47 recognizes the current position/posture of the autonomous mobile body 21, space information indicating the presence/absence, arrangement, and the like of the object in the real space, and object information of an object existing in the real space.

The recognition unit 47 reads the space information and the object information recognized in the past from the storage unit 48, updates the space information and the object information with the read information and the space information and the object information newly recognized with the sensor data, and stores the updated space information and object information in the storage unit 48.

The recognition unit 47 recognizes a movable space, which is a range of a space in which the autonomous mobile body 21 is movable, on the basis of the space information, and supplies the movable space as the movable space information to the target planning unit 42 and the action planning unit 43. Furthermore, the recognition unit 47 supplies the object information to the target planning unit 42.

The storage unit 48 stores host device information, the space information, the object information, and the like. In FIG. 1, only the recognition unit 47 is configured to store and read various types of information in and from the storage unit 48, but the present invention is not limited thereto. It is assumed that components other than the recognition unit 47 such as the target planning unit 42 and the action planning unit 43 can store and read various types of information in and from the storage unit 48 as necessary via the recognition unit 47 or without the recognition unit 47.

(Configuration of Target Planning Unit 42 and the Like)

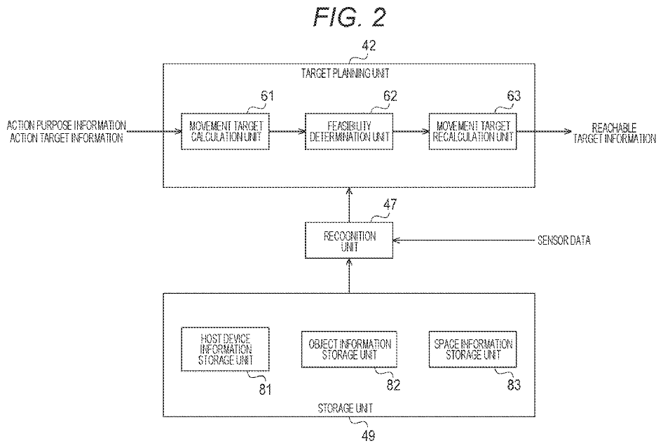

FIG. 2 is a block diagram illustrating a configuration of the target planning unit 42 and the storage unit 48.

The target planning unit 42 includes a movement target calculation unit 61, a feasibility determination unit 62, and a movement target recalculation unit 63.

The movement target calculation unit 61 calculates a temporary movement target on the basis of the action purpose information and the action target information from the operation device 22 designated by the user and the object information from the recognition unit 47. The temporary movement target is a movement target that is a temporary movement destination of the autonomous mobile body 21, and represents a movement target calculated without considering the capability (performance/function such as a moving method) of the autonomous mobile body 21, the range of the movable space of the autonomous mobile body 21 (movable space), and the like.

The movement target calculation unit 61 supplies the calculated temporary movement target to the feasibility determination unit 62 together with the action purpose information from the operation device 22.

The feasibility determination unit 62 determines whether a feasibility of movement of the autonomous mobile body 21 to the temporary movement target from the movement target calculation unit 61 is high or low on the basis of the movable space information from the recognition unit 47.

For example, in a case where the temporary movement target is within the range of the movable space, it is determined that the feasibility is high, and in a case where the temporary movement target is outside the range of the movable space, it is determined that the feasibility is low.

The feasibility determination unit 62 supplies the action purpose information and the temporary movement target from the movement target calculation unit 61, and a determination result of the feasibility for the temporary movement target to the movement target recalculation unit 63.

The movement target recalculation unit 63 calculates a movement target on the basis of the action purpose information, the temporary movement target, and the determination result from the feasibility determination unit 62.

With respect to the temporary movement target for which it is determined that the feasibility is high, the movement target recalculation unit 63 sets the temporary movement target without any change as the final movement target (referred to as a reachable target).

With respect to the temporary movement target for which it is determined that the feasibility is low, the movement target recalculation unit 63 calculates, as the reachable target, a position/posture that is within the range of the movable space and is closest to the temporary movement target.

The movement target recalculation unit 63 supplies reachable target information indicating the calculated reachable target to the action planning unit 43 in FIG. 1 together with the action purpose information.

The storage unit 48 includes a host device information storage unit 81, an object information storage unit 82, and a space information storage unit 83.

The host device information storage unit 81 stores information such as performance, function, and shape of the autonomous mobile body 21 that is the host device.

The object information storage unit 82 stores information regarding an identifier (identification information), a position, a posture, and a shape of an object existing in the real space.

The space information storage unit 83 stores space information (map information) indicating the arrangement of objects existing in the real space.

Note that the host device information is created in advance by an external system and stored in the host device information storage unit 81.

The object information and the space information are created by accumulating information recognized by the recognition unit 47 on the basis of the sensor data acquired by the sensor 46 as information of the object information storage unit 82 and the space information storage unit 83. However, the object information and the space information may be created in an external system in advance and stored in the object information storage unit 82 and the space information storage unit 83.

(Description of Various Information)

Information supplied to the target planning unit 42 and information calculated by the target planning unit 42 will be described.

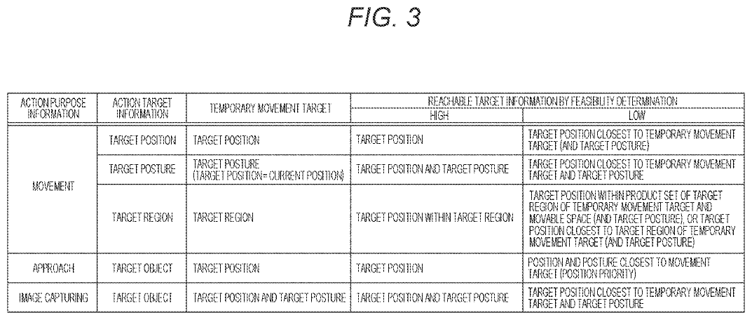

FIG. 3 is a diagram illustrating a list of information supplied to the target planning unit 42 and information calculated by the target planning unit 42.

(Action Purpose Information)

In fields of the action purpose information in the leftmost column (first column) in FIG. 3, types of the action purpose indicated by the action purpose information supplied from the operation device 22 to the target planning unit 42 are exemplified. The action purpose includes, for example, movement, approach, and image-capturing.

In a case where the action purpose is movement, an action for moving to the action target is designated to the autonomous mobile body 21.

In a case where the action purpose is approach, an action of approaching the action target is designated to the autonomous mobile body 21.

In a case where the action purpose is image-capturing, the autonomous mobile body 21 is designated to perform an action of approaching the action target and image-capturing the action target.

Note that the action purpose of the autonomous mobile body 21 that can be designated by the operation device 22, that is, the action purpose information that can be supplied to the target planning unit 42 is not limited to movement, approach, and image-capturing, and can include any action that can be executed by the autonomous mobile body 21 according to the function of the autonomous mobile body 21.

For example, a selection screen for selecting the action purpose to be executed by the autonomous mobile body 21 is displayed on a display unit (not illustrated) of the operation device 22. The user selects and designates the action purpose to be executed by the autonomous mobile body 21 on the selection screen. The action purpose information indicating the action purpose designated by the user is supplied from the operation device 22 to the target planning unit 42 of the autonomous mobile body 21.

(Action Target Information)

In fields of the action target information in the second column of FIG. 3, types of the action target indicated by the action target information supplied from the operation device 22 to the target planning unit 42 are exemplified. There are types of the action target corresponding to action purposes.

In a case where the action purpose is movement, examples of the types of the action target include a target position, a target posture, and a target region.

In a case where the action target is the target position, a position in the real space in which the autonomous mobile body 21 moves is designated.

In a case where the action target is the target posture, a posture in the real space in which the autonomous mobile body 21 moves (changes in posture) is designated.

In a case where the action target is the target region, a region in the real space in which the autonomous mobile body 21 moves is designated.

Note that the type of the action target may be a combination of the target position and the target posture and a combination of the target posture and the target region, but they are omitted in FIG. 3.

For example, a map screen representing a map of a real space in which the autonomous mobile body 21 moves is displayed on the display unit of the operation device 22. The map of the map screen is created on the basis of, for example, the object information and the space information stored in the object information storage unit 82 and the space information storage unit 83 of the storage unit 48 of the autonomous mobile body 21. In this case, the object information and the space information stored in the object information storage unit 82 and the space information storage unit 83 are supplied from the autonomous mobile body 21 to the operation device 22 by communication. However, in a case where the autonomous mobile body 21 and the operation device 22 share the same map information (object information and space information) created in advance, it is not necessary to exchange the map information between the autonomous mobile body 21 and the operation device 22.

After designating movement as the action purpose to be executed by the autonomous mobile body 21, the user designates a target movement destination to the autonomous mobile body 21 on the map screen. At this time, in a case where the user designates a predetermined point on the map as the target movement destination, the position of the designated predetermined point is designated as the target position. Furthermore, in a case where the user designates, for example, a front direction of the autonomous mobile body 21 on the map, a posture facing the designated front direction is designated as the target posture. Furthermore, in a case where the user designates a predetermined region on the map, the designated region is designated as the target region.

The operation device 22 supplies the target planning unit 42 of the autonomous mobile body 21 with the action target information indicating the target position, the target posture, or the target region designated by the user in a case where the action purpose information is movement.

Note that designation of the target position, the target posture, or the target region may be, for example, designation of coordinate values representing the target position in a map coordinate system set on a map, designation of a posture angle (Euler angle, quaternion, or the like) representing the target posture, designation of a region position and a region shape representing the target region, or the like.

An image captured by the camera of the autonomous mobile body 21 may be displayed on the display unit of the operation device 22, and the target position, the target posture, or the target region may be designated on the image.

In FIG. 3, in a case where the action purpose is approach, examples of the types of the action target indicated by the action target information include a target object.

In a case where the action target is the target object, an object in the real space to which the autonomous mobile body 21 approaches is designated. The method of designating the target object as the action target may be a method of designating the identifier of the target object, a method of designating only the type of the target object, or other methods.

Note that, as in the case where the action purpose is movement, it is also possible to designate the target position or the target region as the action target even in a case where the action purpose is approach, and it is also possible to designate the target object as the action target in a case where the action purpose is movement.

For example, as in the case where the action purpose is movement, the map screen representing the map of the real space in which the autonomous mobile body 21 moves is displayed on the display unit of the operation device 22.

After designating approach as the action purpose to be executed by the autonomous mobile body 21, the user designates a target object that the autonomous mobile body 21 is caused to approach on the map screen.

The operation device 22 detects an identifier of the object designated by the user from the object information on the basis of the position (coordinates) of the object designated by the user in the map coordinate system. The operation device 22 supplies the detected identifier of the object to the target planning unit 42 of the autonomous mobile body 21 as the action target information indicating the target object. In a case where the identifier of the object is given as the action target information from the operation device 22, the target planning unit 42 identifies the object designated by the user on the basis of the object information in the object information storage unit 82 and recognizes the target object.

Note that an image captured by the camera of the autonomous mobile body 21 may be displayed on the display unit of the operation device 22, and it may be possible to designate an object such as a person as the target object on the image. In this case, the target planning unit 42 of the autonomous mobile body 21 acquires information of a position designated on the image from the operation device 22, and recognizes an object at the position designated on the image as the target object.

In FIG. 3, in a case where the action purpose is the image-capturing, examples of the types of the action target indicated by the action target information include a target object.

In a case where the action target is the target object, an object in the real space that is a target of image-capturing by the autonomous mobile body 21 is designated.

Note that, as in the case where the action purpose is movement, even in the case where the action purpose is the image-capturing, it is also possible to designate the target position or the target region as the action target.

For example, the map screen representing the map of the real space in which the autonomous mobile body 21 moves is displayed on the display unit of the operation device 22, as in the case where the action purpose is approach.

After designating image-capturing as the action purpose to be executed by the autonomous mobile body 21, the user designates a target object to be image-captured by the autonomous mobile body 21 on the map screen.

The operation device 22 detects the identifier of the object designated by the user from the object information on the basis of the position (coordinates) of the object designated by the user in the map coordinate system. The operation device 22 supplies the detected identifier of the object to the target planning unit 42 of the autonomous mobile body 21 as the action target information indicating the target object. In a case where the identifier of the object is given as the action target information from the operation device 22, the target planning unit 42 identifies the object designated by the user on the basis of the object information in the object information storage unit 82 and recognizes the target object.

Note that, as in the case where the action purpose is approach, it may be possible to designate an object such as a person as the target object on the image captured by the camera of the autonomous mobile body 21.

(Temporary Movement Target)

In fields of the temporary movement target in the third column of FIG. 3, types of the temporary movement target calculated by the movement target calculation unit 61 (see FIG. 2) of the target planning unit 42 are exemplified.

In a case where the action purpose is movement, the movement target calculation unit 61 sets the target position, the target posture, or the target region designated as the action target without any change as a temporary movement target.

In a case where the action purpose is approach, the movement target calculation unit 61 calculates a target position to be a movement destination of the autonomous mobile body 21 as the temporary movement target on the basis of the target object designated as the action target and the object information of the target object.

In the calculation of the temporary movement target, the movement target calculation unit 61 acquires the object information of the target object stored in the object information storage unit 82 via the recognition unit 47 on the basis of the identifier of the target object given as the target information. The movement target calculation unit 61 detects the position of the target object (coordinate values in the map coordinate system) on the basis of the object information of the target object, and calculates the detected position or a position away from the detected position by a certain distance as the target position of the temporary movement target.

Note that the movement target calculation unit 61 may calculate a position at which the autonomous mobile body 21 does not contact the target object as the target position of the temporary movement target on the basis of information such as a shape and a size of the autonomous mobile body 21 included in the host device information of the host device information storage unit 81. In addition, the movement target calculation unit 61 may calculate the position at which the autonomous mobile body 21 does not contact the target object in consideration of a shape, a posture, and the like of the target object included in the object information of the object information storage unit 82. Moreover, the movement target calculation unit 61 may calculate, as the target position, a position that satisfies a predetermined condition regarding approach or a condition designated by the user or the like. An employable condition may be, for example, a condition that limits the position where the autonomous mobile body 21 approaches to a front side, a side surface side, a back side, or the like of the target object.

In a case where the action purpose information is image-capturing, the movement target calculation unit 61 calculates a target position to be a movement destination of the autonomous mobile body 21 as the temporary movement target on the basis of the target object designated as the action target and the object information of the target object.

In the calculation of the temporary movement target, the movement target calculation unit 61 acquires the object information of the target object stored in the object information storage unit 82 via the recognition unit 47 on the basis of the identifier of the target object given as the target information. The movement target calculation unit 61 detects the position of the target object (coordinate values in the map coordinate system) on the basis of the object information of the target object, and calculates the position of the autonomous mobile body 21 in which the target object is included within an image-capturing range of the camera (imaging device) provided in the autonomous mobile body 21 as the target position of the temporary movement target.

The movement target calculation unit 61 calculates the posture of the autonomous mobile body 21 with which the target object appears at an appropriate position within the image-capturing range of the camera (imaging device) as the target posture of the temporary movement target in consideration of an image-capturing direction of the camera included in the autonomous mobile body 21. However, in a case where the autonomous mobile body 21 includes a mechanism that controls the image-capturing direction of the camera without changing the posture, the target posture of the temporary movement target may not be considered. In the fields of the temporary movement target in the third column of FIG. 3, a case where the target position and the target posture are set in the field of the case where the action purpose is the image-capturing (further, in a case where the action target is the target object) as an example of the temporary movement target is illustrated.

Note that the movement target calculation unit 61 may calculate, as the target position, a position that satisfies a predetermined condition regarding image-capturing or a condition designated by the user or the like. The employable condition may be, for example, a condition that limits the direction of capturing an image of the target object to the front side, the side surface side, the back side, or the like of the target object.

(Reachable Target)

In fields of the reachable target in the fourth column of FIG. 3, types of the reachable target calculated by the movement target recalculation unit 63 in cases where the determination result of the feasibility by the feasibility determination unit 62 (see FIG. 2) is high and low are exemplified.

Here, the movable space used by the feasibility determination unit 62 to determine the feasibility is defined as a set of positions (points) where the autonomous mobile body 21 can exist. The movable space is determined not only by the presence or absence of an object in the real space, but also by considering a moving method of the autonomous mobile body 21. For example, in a case where the moving method of the autonomous mobile body 21 can move in the air like a flying type, there is a limitation on the movable space by the presence of an object or a flight prohibited region in which the flight is prohibited, but there is no limitation by the moving method.

On the other hand, in a case where the moving method of the autonomous mobile body 21 is a method of moving while contacting a surface (referred to as a moving surface) such as a ground surface or a floor, or while maintaining a substantially constant distance, such as a vehicle type or a multileg type, the movable space is limited to a range along the moving surface on which the autonomous mobile body 21 can move.

In a case where a more detailed definition of the movable space is employed in such a definition of the movable space, the feasibility determination unit 62 may employ a first definition in which the size of the autonomous mobile body 21 is regarded as a point without considering the size of the autonomous mobile body 21, or the like, and a second definition in which the size of the autonomous mobile body 21 or the like is considered.

In the first definition, even if the position of the autonomous mobile body 21 is within the range of the movable space, in a case where an object surface (excluding the moving surface) exists close to the autonomous mobile body 21, a part of the autonomous mobile body 21 may interfere with (intersect) the object depending on the posture of the autonomous mobile body 21. Therefore, in a case where the distance between the target position of the temporary movement target and the object surface (excluding the moving surface) near the target position is equal to or more than a predetermined threshold, it is determined that the feasibility is high, and in a case where the distance is less than the threshold, it is determined that the feasibility is low. The threshold may be, for example, a distance at which the entire autonomous mobile body 21 does not interfere with the object in any posture that can be taken at each position. However, the threshold may not be a value based on the actual size (and shape) of the autonomous mobile body 21. In a case where there is a possibility that the autonomous mobile body 21 interferes with the object due to the posture, the movable space may be defined so as to be out of the range of the movable space. In this case, it is not necessary to consider the interference between the autonomous mobile body 21 and the object in the determination of the feasibility.

In the second definition, the movable space is defined by limiting the posture in which the autonomous mobile body 21 does not interfere with the object in consideration of the size of the autonomous mobile body 21 and the like. That is, a set of positions where the autonomous mobile body 21 can exist without interfering with the object in any one of the postures that the autonomous mobile body 21 can take is defined as the movable space. Note that a set of postures in which the autonomous mobile body 21 does not interfere with the object at each position in the movable space is referred to as a posture-limited range.

Therefore, in a case where the target position of the temporary movement target is within the range of the movable space, when the target posture is not set as the temporary movement target (when the posture is arbitrary), or when the target posture set as the temporary movement target (target posture of the temporary movement target) is within the posture-limited range at the target position of the temporary movement target, it is determined that the feasibility is high.

On the other hand, in a case where the target position of the temporary movement target is outside the range of the movable space or when the target posture of the temporary movement target is outside the posture-limited range in a case where the target position of the temporary movement target is within the range of the movable space, it is determined that the feasibility is low.

In the following description, the feasibility determination unit 62 uses the second definition of the movable space. However, the detailed definitions such as the first and second definitions may not be used as the definition of the movable space. In this case, the interference with the object due to the posture of the autonomous mobile body 21 is not considered, or a range in which the autonomous mobile body 21 does not interfere with the object regardless of the posture of the autonomous mobile body 21 is defined as a movable range.

In a case where only the target position is set as the temporary movement target (in FIG. 3, a case where the action purpose is movement and the action target is the target position, or a case where the action purpose is approach and the action target is the target object), the feasibility determination unit 62 determines that the feasibility is high when the target position is within the range of the movable space. In this case, the movement target recalculation unit 63 sets the target position of the temporary movement target as the reachable target without any change as in the field of “High” among the fields of the reachable target in the fourth column of FIG. 3.

In a case where only the target posture is set as the temporary movement target (in FIG. 3, in a case where the action purpose is movement and the action target is the target posture), the current position of the autonomous mobile body 21 is the same as in a case where the current position is set as the target position of the temporary movement target. Therefore, the feasibility determination unit 62 determines the feasibility as in a case described later in which the target position and the target posture are set as the temporary movement target.

In a case where only the target region is set as the temporary movement target (in FIG. 3, in a case where the action purpose is movement and the action target is the target region), the feasibility determination unit 62 determines that the feasibility is high when the target region (the entire region) is within the range of the movable space. In this case, the movement target recalculation unit 63 sets an arbitrary position included in the target region of the temporary movement target as the target position of the reachable target as in the field of “High” among the fields of the reachable target in the fourth column of FIG. 3.

In a case where the target position and the target posture are set as the temporary movement target (in FIG. 3, in a case where the action purpose is the image-capturing and the action target is the target object), the feasibility determination unit 62 determines that the feasibility is high when the target position is within the range of the movable space and when the target posture is within the posture-limited range. In this case, the movement target recalculation unit 63 sets the target position and the target posture of the prerequisite movement target as the reachable target without any change as in the field of “High” among the fields of the reachable target in the fourth column of FIG. 3.

In a case where the above-described condition for determining that the feasibility is high is not satisfied, the feasibility determination unit 62 determines that the feasibility is low. In this case, the movement target recalculation unit 63 recalculates a movement target having a higher feasibility than the temporary movement target as follows using the information of the movable space, and sets the movement target as the reachable target that is a final movement target. In the field of “Low” among the fields of the reachable target in the fourth column of FIG. 3, an outline of the calculated reachable target is illustrated, and details are as follows.

In a case where only the target position is set as the temporary movement target, the movement target recalculation unit 63 calculates a position closest to the target position of the temporary movement target within the range of the movable space, and sets the position as the target position of the reachable target. Furthermore, the movement target recalculation unit 63 sets an arbitrary posture within the posture-limited range at the set target position of the reachable target as the target posture of the reachable target. However, in a case where the posture of the autonomous mobile body 21 is not limited at the target position of the reachable target, the target posture may not be set. Furthermore, in a range in which the posture of the autonomous mobile body 21 is not limited in the movable space, a position closest to the target position of the temporary movement target may be set as the target position of the reachable target.

The case where only the target posture is set as the temporary movement target is the same as the case where the current position of the autonomous mobile body 21 is set as the target position of the temporary movement target. Therefore, the feasibility determination unit 62 calculates the reachable target as in a case described later in which the target position and the target posture are set as the temporary movement target.

In a case where only the target region is set as the temporary movement target, when a product set of the target region of the temporary movement target and the movable space is not an empty set, the movement target recalculation unit 63 sets an arbitrary position included in the product set as the target position of the reachable target.

When the product set of the target region of the temporary movement target and the movable space is an empty set, the movement target recalculation unit 63 calculates a position closest to the temporary movement target region within the range of the movable space, and sets the position as the target position of the reachable target.

The movement target recalculation unit 63 sets an arbitrary posture within the posture-limited range at the set target position of the reachable target as the target posture of the reachable target. However, in a case where the posture of the autonomous mobile body 21 is not limited at the target position of the reachable target, the target posture may not be set. Any position in a product set of a range in which the posture of the autonomous mobile body 21 is not limited in the movable space and the target region of the temporary movement target, or a position closest to the target region of the temporary movement target in the range in which the posture of the autonomous mobile body 21 is not limited in the movable space, may be set as the target position of the reachable target.

In a case where the target position and the target posture are set as the temporary movement target, for example, the following first to third calculation methods can be employed as a method of calculating a feasible target of the movement target recalculation unit 63.

In the first calculation method, the movement target recalculation unit 63 calculates a position closest to the target position of the temporary movement target within the range of the movable space, and sets the position as the target position of the reachable target. The movement target recalculation unit 63 calculates a posture closest to the target posture of the temporary movement target in the posture-limited range at the set target position of the reachable target, and sets the calculated posture as the target posture of the reachable target. The posture closest to the target posture means a posture having a minimum posture distance to the target posture. The posture distance is a value representing the magnitude of the difference between the two postures, and for example, in a case where a posture change from one of the two postures to the other is represented by a rotation angle around one rotation axis, the magnitude of the rotation angle may be used as the posture distance, or other definitions may be employed.

In the second calculation method, the movement target recalculation unit 63 sets the target posture of the temporary movement target as the target posture of the reachable target. Then, the movement target recalculation unit 63 calculates a position closest to the target position in the range of the movable space in which the target posture is a posture within the posture-limited range, and sets the position as the target position of the feasible target.

In the third calculation method, the movement target recalculation unit 63 calculates a position within the range of the movable space and a posture within the posture-limited range that minimize a linear sum (weighted sum) of a distance (geometric distance) of the temporary movement target to the target position and a posture distance of the temporary movement target to the target posture. The weighted sum represents an overall distance regarding the position and the posture with respect to the target position and the target posture of the temporary movement target. The movement target recalculation unit 63 calculates, as the reachable target, a position within the range of the movable space and a posture within the posture-limited range that are closest to the target position and the target posture of the temporary movement target with respect to the overall distance. The movement target recalculation unit 63 sets the calculated position and posture as the position and posture of the reachable target.

In the calculation of the weighted sum of the geometric distance and the posture distance, values determined in advance are used as a first weight to be multiplied by the geometric distance and a second weight to be multiplied by the posture distance.

The first and second weights mean that, for example, as the ratio of the first weight to the second weight becomes larger, higher priority is given to bringing the target position of the reachable target closer to the target position of the temporary movement target than with respect to the posture.

On the contrary, the first and second weights mean that as the ratio of the first weight to the second weight becomes smaller, higher priority is given to bringing the target posture of the reachable target closer to the target posture of the temporary movement target rather than with respect to the position.

Note that the first calculation method corresponds to a case where the second weight is 0 (the first weight is a positive number) in the third calculation method. Furthermore, the second calculation method corresponds to a case where the first weight is 0 (the second weight is a positive number) in the third calculation method. Hereinafter, the movement target recalculation unit 63 will be described assuming that the third calculation method is used.

The movement target recalculation unit 63 may calculate the target position and the target posture of the reachable target by the third calculation method using the first and second weights having predetermined values, or may calculate the reachable target by switching the first and second weights in the third calculation method according to the action purpose information and the action target information.

For example, in a case where the action purpose is movement and the action target is only the target posture (the current position is regarded as the target position), the movement target recalculation unit 63 calculates the reachable target by reducing the first weight for the second weight, for example. Thus, it is prioritized over the position that the target posture of the reachable target does not greatly differ from the target posture of the temporary movement target.

Furthermore, in a case where the action purpose is movement and the action target is the target position and the target posture, or in a case where the action purpose is the image-capturing and the action target is the target object, for example, the movement target recalculation unit 63 calculates the reachable target by making the first weight for the second weight larger than that in the above case. Thus, it is possible to prevent one of the target position and the target posture of the reachable target from being greatly different from the target position and the target posture of the temporary movement target.

(Description of Operation of First Embodiment of Autonomous Mobile Body Control System)

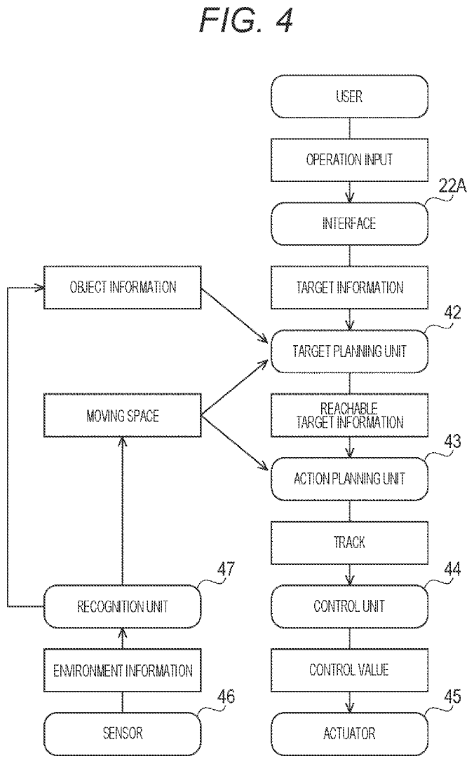

FIG. 4 is a diagram illustrating a flow of information of the autonomous mobile body control system 11. An operation of the autonomous mobile body control system 11 will be described with reference to FIG. 4.

In the autonomous mobile body control system 11, an operation input of the user to the autonomous mobile body 21 is received by the interface 22A using the operation device 22. Thus, the action purpose information and the action target information designated by the user are supplied to the target planning unit 42 of the autonomous mobile body control system 11 via the interface 22A.

The target planning unit 42 calculates the target position and the target posture to which the autonomous mobile body 21 is movable as the reachable target information on the basis of the action purpose information and the action target information designated by the user, and the object information and information (space information) regarding moving space (movable space) from the recognition unit 47, and the like. The reachable target information is supplied to the action planning unit 43.

The action planning unit 43 calculates a track (action plan representing an action process such as a movement path) until reaching the reachable target indicated by the reachable target information on the basis of the reachable target information from the target planning unit 42, and the information of the moving space from the recognition unit 47, and the like, and supplies the track to the control unit 44.

The control unit 44 calculates a control value for controlling the actuator 45 according to the track (action plan) from the action planning unit 43, and supplies the control value to the actuator 45.

The actuator 45 generates power according to the control value from the control unit 44 to cause the autonomous mobile body 21 to move or execute other actions.

On the other hand, the sensor 46 detects the position and posture of the autonomous mobile body 21, and environment information regarding a surrounding object and the like, and supplies the detected information to the recognition unit 47.

The recognition unit 47 recognizes the object information and the moving space information (information of the movable space) on the basis of the environment information from the sensor 46, the past information stored in the storage unit 48 (see FIGS. 1 and 2) not illustrated in FIG. 4, and information stored in advance. The object information is supplied to the target planning unit 42, and the moving space information is supplied to the target planning unit 42 and the action planning unit 43.

(Processing Procedure of First Embodiment of Autonomous Mobile Body Control System)

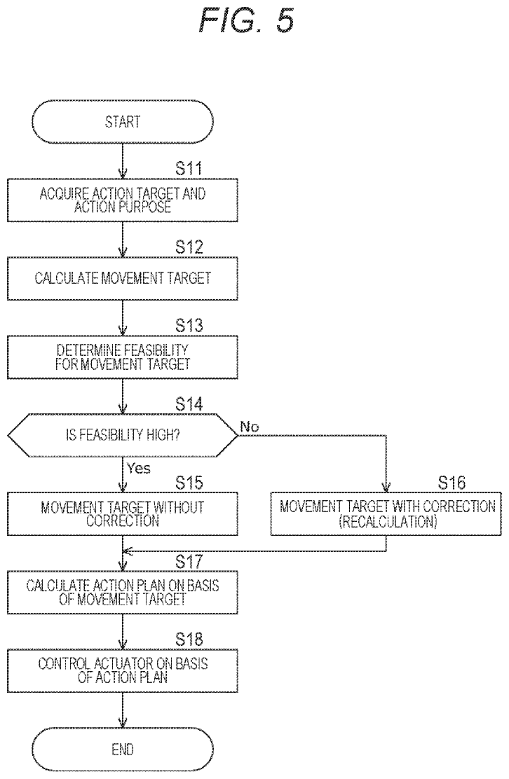

FIG. 5 is a flowchart illustrating a processing procedure performed by the autonomous mobile body control system 11.

In step S11, the target planning unit 42 of the autonomous mobile body 21 acquires the action purpose and the action target designated by the user. The processing proceeds from step S11 to step S12.

In step S12, the target planning unit 42 calculates a movement target (temporary movement target) that does not consider feasibility on the basis of the action purpose and the action target acquired in step S11. The processing proceeds from step S12 to step S13.

In step S13, the target planning unit 42 determines the level of feasibility for the temporary movement target calculated in step S12. The processing proceeds from step S13 to step S14.

In step S14, the target planning unit 42 performs branch processing on the basis of the level of a determination result in step S13.

In step S14, in a case where it is determined that the feasibility is high as the determination result in step S13, the processing proceeds to step S15.

In step S15, the target planning unit 42 sets the temporary movement target calculated in step S12 as the reachable target without correction. The processing proceeds from step S15 to step S17.

In step S14, in a case where it is determined that the feasibility is low as the determination result in step S13, the processing proceeds to step S16.

In step S16, the target planning unit 42 corrects the temporary movement target calculated in step S12 to a movement target with high feasibility and sets the movement target as the reachable target. The processing proceeds from step S16 to step S17.

In step S17, the action planning unit 43 of the autonomous mobile body 21 calculates the action plan representing the track or the like of the autonomous mobile body 21 for achieving the action purpose and the action target on the basis of the movement target (reachable target) set in step S15 or step S16. The processing proceeds from step S17 to step S18.

In step S18, the control unit 44 of the autonomous mobile body 21 controls the actuator 18 according to the action plan calculated in step S17.

Every time the user designates a new movement purpose and a new movement target, the processing from step S11 to step S18 is executed.

(Description of Effectiveness of First Embodiment of Autonomous Mobile Body Control System)

According to the first embodiment of the autonomous mobile body control system, the autonomous mobile body 21 executes an action within a feasible range with respect to the action purpose and the action target designated by the user according to the capability of the host device, the state of the moving space, and the like.

Therefore, it is possible to designate the action purpose and the action target without depending on the capability of the autonomous mobile body 21, the state of the moving space, and the like.

Even in a case where it is impossible to completely achieve the designated action purpose and action target, it is possible to cause the autonomous mobile body 21 to execute a suitable action for the purpose within the feasible range, and it is possible to cause the autonomous mobile body 21 to flexibly cope with the action purpose and the action target.

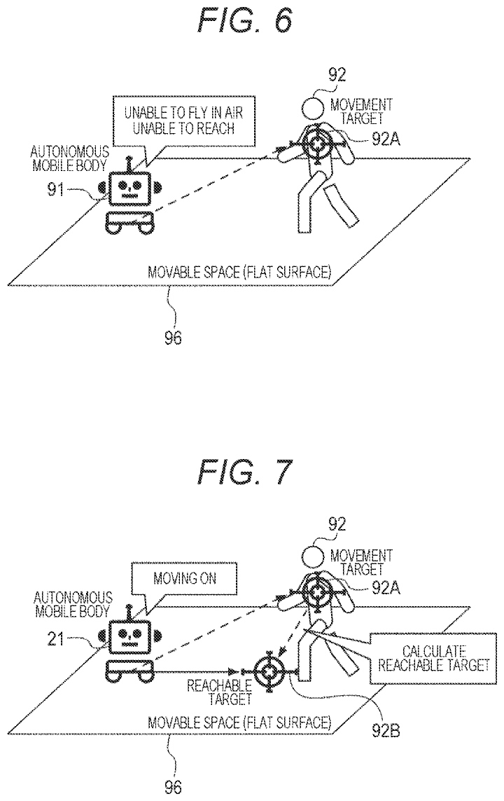

FIG. 6 is a diagram illustrating an operation of an autonomous mobile body of a comparative example with respect to an example of the action purpose and the action target.

In FIG. 6, an autonomous mobile body 91 which is an autonomous mobile body of the comparative example moves along the moving surface (movable space 96) such as a ground or a floor by a vehicle-type moving method, for example. The moving surface is exemplified as a flat surface in FIG. 6, and the movable space 96, which is a range of the movable space of the autonomous mobile body 91, is represented as a flat surface.

FIG. 6 illustrates a case where the user designates a position around the chest of a person 92 existing in the space as a movement target 92A (target position) of the action target in a case where the action purpose is movement.

The autonomous mobile body 91 of the comparative example is, for example, an autonomous mobile body to which the technology described in Patent Document 1 (see Japanese Patent Application Laid-Open No. 2006-195969) is applied. The autonomous mobile body 91 has a function of planning a movement path (track) to a designated movement target 92A while avoiding obstacles. However, it is assumed that the movement target 92A is within the range of the movable space. Therefore, in a case where the movement target 92A is a position that the autonomous mobile body 91 cannot reach, the movement path cannot be planned. For example, in a case where the movement target 92A that is unreachable is designated, the autonomous mobile body 91 responds to notify the user of error information or the like indicating that movement is not possible.

FIG. 7 is a diagram illustrating the operation of the autonomous mobile body 21 of the present embodiment with respect to the action purpose and the action target similar to those in FIG. 6. Note that, in the drawing, the same parts as those in FIG. 6 are denoted by the same reference numerals as those in FIG. 6, and description thereof is omitted.

In FIG. 7, the autonomous mobile body 21 moves in the range of the movable space 96 along the moving surface by the vehicle-type moving method similarly to the autonomous mobile body 91 of the comparative example. The movement target 92A (target position) as the action target designated by the user is out of the range of the movable space 96.

In this case, the autonomous mobile body 21 corrects the movement target 92A to a position within the range of the movable space 96, and sets the corrected position as a reachable target 92B. The autonomous mobile body 21 calculates a track to the reachable target 92B, and moves to the reachable target 92B along the calculated track.

As described above, the autonomous mobile body 21 executes movement within the feasible range with respect to the movement target designated by the user according to the capability of the host device, or the like.

Therefore, even in a case where the user designates the action purpose and the action target that cannot be achieved without considering the capability of the autonomous mobile body 21 or the like, it is not necessary for the user to take time and effort to re-designate the action purpose and the action target. The user can designate the action purpose and the action target without depending on the capability of the autonomous mobile body 21, the state of the moving space, and the like.

Even in a case where it is impossible to completely achieve the designated action purpose and action target, it is possible to cause the autonomous mobile body 21 to execute a suitable action for the purpose within the feasible range, and it is possible to cause the autonomous mobile body 21 to flexibly cope with the action purpose and the action target. The degree of freedom of the instruction content to the autonomous mobile body 21 is high, and the operability is improved.

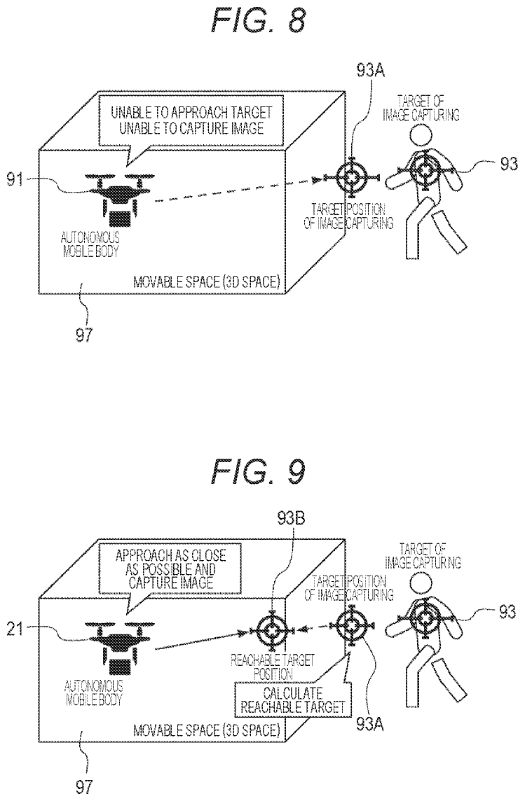

FIG. 8 is a diagram illustrating an operation of an autonomous mobile body of a comparative example with respect to an example of the action purpose and the action target.

In FIG. 8, the autonomous mobile body 91, which is the autonomous mobile body of the comparative example, moves in the air by, for example, a flying-type moving method. The movable space 97, which is a range of the movable space of the autonomous mobile body 91, is represented by a three-dimensional space.

FIG. 8 illustrates a case where the user designates movement to a movement target 93A (target position) as an action target, with the camera mounted on the autonomous mobile body 91, for the action purpose of capturing an image of the person 93 present outside the range of the movable space 97 (for example, the flight prohibited region).

In this case, since the movement target 93A is out of the range of the movable space 97 of the autonomous mobile body 91, the movement path to the movement target 93A cannot be planned as in the case of FIG. 6. Therefore, the autonomous mobile body 91 responds to notify the user of error information or the like indicating that the autonomous mobile body cannot move.

FIG. 9 is a diagram illustrating the operation of the autonomous mobile body 21 of the present embodiment with respect to the action purpose and the action target similar to those in FIG. 8. Note that, in the drawing, the same parts as those in FIG. 8 are denoted by the same reference numerals as those in FIG. 8, and description thereof is omitted.

In FIG. 9, the autonomous mobile body 21 moves in the range of the movable space 97, which is a three-dimensional space, by a flying-type moving method, similarly to the autonomous mobile body 91 of the comparative example. A case where the user designates the image-capturing as the action purpose and designates the person 93 as the action target is illustrated.

The autonomous mobile body 21 calculates a movement target 93A (target position) that can capture an image of the person 93 as a temporary movement target not considering the movable space 97. FIG. 9 illustrates a case where the movement target 93A is outside the range of the movable space 97 as in the case of FIG. 8.

In this case, the autonomous mobile body 21 corrects the movement target 93A to a position within the range of the movable space 97, and sets the corrected position as the reachable target 93B. The autonomous mobile body 21 calculates a track to the reachable target 93B, and moves to the reachable target 93B along the calculated track.

As described above, the autonomous mobile body 21 executes movement within the feasible range with respect to the movement target designated by the user according to the capability of the host device, or the like.

Therefore, even in a case where the user designates an action purpose and an action target that cannot be achieved without considering the capability of the autonomous mobile body 21, a movable space region, and the like, it is not necessary for the user to take time and effort to re-designate the action purpose and the action target. The user can designate the action purpose and the action target without depending on the capability of the autonomous mobile body 21, the state of the moving space, and the like.

Even in a case where it is impossible to completely achieve the designated action purpose and action target, it is possible to cause the autonomous mobile body 21 to execute a suitable action for the purpose within the feasible range, and it is possible to cause the autonomous mobile body 21 to flexibly cope with the action purpose and the action target. The degree of freedom of the instruction content to the autonomous mobile body 21 is high, and the operability is improved.

<Configuration of Second Embodiment of Autonomous Mobile Body Control System to Which Present Technology is Applied>

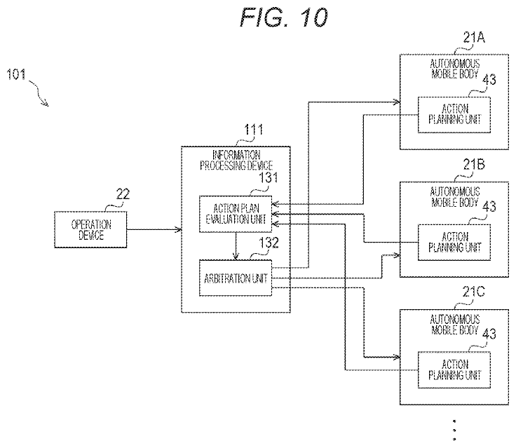

FIG. 10 is a block diagram illustrating a configuration of a second embodiment of an autonomous mobile body control system to which the present technology is applied. Note that, in the drawing, parts corresponding to those of the autonomous mobile body control system 11 in FIG. 1 are denoted by the same reference numerals or are denoted by alphabets A, B, C, . . . at the end of the same reference numerals, and a detailed description thereof will be omitted.

The autonomous mobile body control system 101 in FIG. 10 includes a plurality of autonomous mobile bodies 21A, 21B, 21C, . . . , an operation device 22, and an information processing device 111. Therefore, the autonomous mobile body control system 101 of FIG. 10 is common to the case of FIG. 1 in including the operation device 22 and the autonomous mobile bodies 21A, 21B, 21C, . . . , and so on. However, the autonomous mobile body control system 101 of FIG. 10 is different from the case of FIG. 1 in that it includes a plurality of autonomous mobile bodies 21A, 21B, 21C, . . . and that an information processing device 111 is newly provided.

Each of the autonomous mobile bodies 21A, 21B, 21C, . . . corresponds to the autonomous mobile body 21 in FIG. 1, and is a mobile body that moves by an arbitrary moving method. Note that, hereinafter, the autonomous mobile bodies 21A, 21B, 21C, . . . are also collectively referred to as the autonomous mobile body 21.

Some or all of the moving methods of the autonomous mobile bodies 21 may be the same or different.

Each of the autonomous mobile bodies 21A, 21B, 21C, . . . corresponds to the autonomous mobile body 21 in FIG. 1, and is a mobile body that moves by an arbitrary moving method. Note that, hereinafter, the autonomous mobile bodies 21A, 21B, 21C, . . . are also collectively referred to as the autonomous mobile body 21.

Some or all of the moving methods of the autonomous mobile bodies 21 may be the same or different.

Each autonomous mobile body 21 is common to the autonomous mobile body 21 in FIG. 1 in including the transmission-reception unit 41, the target planning unit 42, the action planning unit 43, the control unit 44, the actuator 45, the sensor 46, the recognition unit 47, and the storage unit 48 which are not illustrated in FIG. 10. However, the autonomous mobile body 21 is different from the autonomous mobile body 21 in FIG. 1 in that the action plan (track) calculated by the action planning unit 43 is supplied to the information processing device 111 and that the control unit 44 determines whether or not to execute control of the actuator 45 in accordance with an instruction from the information processing device 111.

Similarly to the operation device 22 in FIG. 1, the operation device 22 receives the action purpose information and the action target information of the autonomous mobile body 21, which are operationally input by the user. The operation device 22 supplies the action purpose information and the action target information designated by the user to the information processing device 111 by wireless or wired communication. Note that communication between the operation device 22 and the information processing device 111 may be via a network such as the Internet, or is not limited to a specific communication method as long as information can be exchanged.

The information processing device 111 may be, for example, a server device, a personal computer, a smartphone, a tablet, or the like, and may be included in the operation device 22. The information processing device 111 may be included in any of the autonomous mobile bodies 21.

The information processing device 111 supplies the action purpose information and the action target information from the operation device 22 to each autonomous mobile body 21 by communication. Communication between the information processing device 111 and each autonomous mobile body 21 is not limited to a specific communication method as long as information can be exchanged.

As a result of supplying the action purpose information and the action target information to each autonomous mobile body 21, the information processing device 111 acquires, from each autonomous mobile body 21, information of an action plan (track or the like) calculated by the action planning unit 43 of each autonomous mobile body 21.

On the basis of the action plan acquired from each autonomous mobile body 21, the information processing device 111 selects one or more of the autonomous mobile bodies 21 that cause an action corresponding to the action purpose and the action target designated by the user to be executed, from among all the autonomous mobile bodies 21.

The information processing device 111 instructs the selected autonomous mobile body 21 to execute an action based on the action plan.

(Configuration of Information Processing Device 111)

The information processing device 111 includes an action plan evaluation unit 131 and an arbitration unit 132.

The action plan evaluation unit 131 calculates an evaluation index of each autonomous mobile body 21 on the basis of the action plan acquired from each autonomous mobile body 21. The evaluation index is a value for evaluating superiority/inferiority (superiority/inferiority of action) in a case where an action purpose is executed. For example, the evaluation index is calculated on the basis of an evaluation target such as the degree of achievement of the action purpose, a travel time occurring in a case where an action plan is executed, an energy consumption amount, safety, or a noise amount.

The degree of achievement of the action purpose represents, for example, the magnitude of a deviation (overall distance) between the temporary movement target calculated from the action purpose and the action target and the reachable target calculated in consideration of the movable range and the like. The smaller the deviation, the greater the degree of achievement of the action purpose.

The safety is a value quantified with respect to safety to the surroundings and a failure risk of the host device. The amount of noise is an amount of noise related to noise emitted by the host device or noise recorded by image-capturing or the like. In addition to these evaluation targets, in a case where the action purpose is the image-capturing, how the target appears in image-capturing or the brightness of the captured image can be evaluated. In addition, an average, a variance, or the like of the evaluation values of the respective evaluation targets may be set as the evaluation targets (for example, the estimated movement time and its variance, and the like).

In the case of quantifying each evaluation target, for example, the more excellent the action (action plan), the larger the quantified value (evaluation value) or the smaller the quantified value (evaluation value). In the present embodiment, the former case is employed.

The evaluation index is, for example, a linear sum (weighted sum) of evaluation values of the respective evaluation targets. A weight to be multiplied by each evaluation value is determined in advance. Note that, by setting any one or more of the weights to be multiplied by each evaluation value to 0, the evaluation target contributing to the evaluation index is reduced. Therefore, the evaluation index calculated by the linear sum of the evaluation values of the respective evaluation targets is calculated on the basis of any one or more evaluation values of the evaluation targets as described above.

The action plan evaluation unit 131 supplies the action plan from each autonomous mobile body 21 and the evaluation index calculated for each action plan to the arbitration unit 132.

The arbitration unit 132 selects the autonomous mobile body 21 to be caused to execute an action according to the action plan on the basis of the action plan acquired from the action plan evaluation unit 131 and the evaluation index thereof. In other words, the arbitration unit 132 selects an action plan to be executed from among the action plans acquired from the action plan evaluation unit 131.

For example, in a case where it is sufficient for one autonomous mobile body 21 to achieve the action purpose such that the action purpose designated by the user is movement or approach, the arbitration unit 132 selects one autonomous mobile body 21 that executes the action corresponding to the action purpose on the basis of the evaluation index of the action plan of each autonomous mobile body 21.

However, even in a case where the action purpose designated by the user is movement or approach, for example, when the user designates the number of autonomous mobile bodies 21 to be caused to execute the action corresponding to the action purpose, or the like, the arbitration unit 132 selects the designated number of autonomous mobile bodies 21.

In a case of selecting one autonomous mobile body 21, the arbitration unit 132 selects the corresponding autonomous mobile body 21 with the evaluation index having the largest value among the evaluation indexes of the action plan of each autonomous mobile body 21. The arbitration unit 132 supplies the selected autonomous mobile body 21 with the action plan acquired from the autonomous mobile body 21, and instructs execution of the action plan. However, the autonomous mobile body 21 may hold the action plan calculated by the host device, so that the arbitration unit 132 may only instruct the selected autonomous mobile body 21 to execute the action plan.

For example, in a case where efficiency is improved in a case where a plurality of autonomous mobile bodies 21 executes the action corresponding to the action purpose such as image-capturing or transportation as the action purpose designated by the user, the arbitration unit 132 selects a plurality of autonomous mobile bodies 21 that executes the action corresponding to the action purpose on the basis of the evaluation index of the action plan of each autonomous mobile body 21.

Note that, in a case of selecting one autonomous mobile body 21, the arbitration unit 132 has a choice order for the autonomous mobile body 21 in descending order of the evaluation index. In a case where the arbitration unit 132 causes the autonomous mobile body 21 of the first choice order with the maximum value of the evaluation index to execute the action plan, when the autonomous mobile body 21 fails in the action or cannot continue the action, the arbitration unit 132 may instruct the autonomous mobile body 21 of the second choice order to execute the action plan.

The arbitration unit 132 may cause the plurality of autonomous mobile bodies 21 having a high choice order to simultaneously execute the action plan for backup.

Similarly, in a case where the user designates the number of autonomous mobile bodies 21 to be caused to execute the action corresponding to the action purpose, the arbitration unit 132 causes the designated number of autonomous mobile bodies 21 among the autonomous mobile bodies 21 having high choice orders to simultaneously execute the action plan.

In a case of selecting the plurality of autonomous mobile bodies 21, the arbitration unit 132 refers to information of an achievement amount that can be achieved by each autonomous mobile body 21 for the action purpose. The achievement amount is information created in advance on the basis of the capability or the like of each autonomous mobile body 21. The created information of the achievement amount is stored in a storage unit (not illustrated) of the information processing device 111 that can be referred to by the arbitration unit 132.

For example, when the action purpose is transportation, the achievement amount may be the maximum transportation amount of each autonomous mobile body 21, and when the action purpose is image-capturing, the achievement amount may be an evaluation value representing the number of cameras mounted on each autonomous mobile body 21 or the level of performance.

The user designates a target amount necessary for achieving the action purpose corresponding to the designated action purpose. The designated target amount is supplied to the information processing device 111 together with the action purpose information, and is referred to the arbitration unit 132.

The arbitration unit 132 detects, as a selection choice, a combination in which the sum or the linear sum of the achievement amounts corresponding to the action purpose is equal to or more than a comparison value using the target amount designated by the user as the comparison value, from arbitrary combinations of all the autonomous mobile bodies 21. However, the comparison value may be a value (1+k) times the target amount designated by the user. k is a positive value and represents a safety factor. Thus, a combination of the number of autonomous mobile bodies 21 having a margin as compared with the case where the comparison value is the target amount designated by the user is detected as the selection choice.

The arbitration unit 132 calculates the sum of the evaluation indexes of the action plan for each of the combinations detected as the selection choices, and detects a combination having the highest sum.

The arbitration unit 132 supplies the action plan acquired from each of the detected combinations to each autonomous mobile body 21, and instructs execution of the action plan.

Note that, also in a case of selecting the plurality of autonomous mobile bodies 21, the arbitration unit 132 has a choice order for the combinations of the autonomous mobile bodies 21 as the selection choices in descending order of the sum of the evaluation indexes as in the case of selecting one autonomous mobile body 21. In a case where the action plan is executed for each autonomous mobile body 21 of the combination having the first choice order in which the sum of the evaluation indexes is the maximum value, when any of the autonomous mobile bodies 21 fails in the action or cannot continue the action, the arbitration unit 132 may instruct the autonomous mobile body 21 of the combination having the second choice order to execute the action plan.

The arbitration unit 132 may cause a plurality of combinations of the autonomous mobile bodies 21 having the high choice order to simultaneously execute the action plan for backup.

(Description of Operation of Autonomous Mobile Body Control System 101)

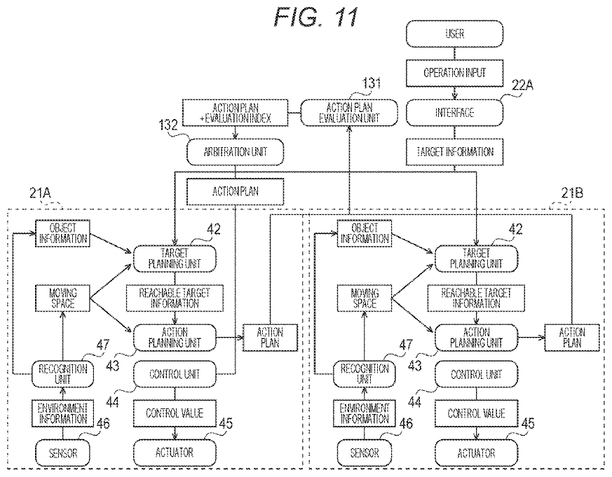

FIG. 11 is a diagram illustrating a flow of information of the autonomous mobile body control system 101. An operation of the autonomous mobile body control system 101 will be described with reference to FIG. 11. Note that, in the drawing, two autonomous mobile bodies 21A and 21B are illustrated as examples of the plurality of autonomous mobile bodies 21.

In the autonomous mobile body control system 101, an operation input of the user is received by the interface 22A using the operation device 22. Thus, the action purpose information and the action target information designated by the user are supplied to the information processing device 111 of the autonomous mobile body control system 11 via the interface 22A, and are supplied from the information processing device 111 to the target planning unit 42 of each of the autonomous mobile bodies 21A and 21B.

In each of the autonomous mobile bodies 21A and 21B, the target planning unit 42 calculates the target position and the target posture to which the autonomous mobile body 21 is movable as the reachable target information on the basis of the action purpose information and the action target information designated by the user, and the object information and the information of the moving space (movable space) from the recognition unit 47, and the like. The reachable target information is supplied to the action planning unit 43.

The action planning unit 43 calculates an action plan representing an action process such as a track until reaching the reachable target indicated by the reachable target information on the basis of the reachable target information from the target planning unit 42, and the information of the moving space from the recognition unit 47, and the like.

The action plan calculated in each of the autonomous mobile bodies 21A and 21B is supplied to the action plan evaluation unit 131 of the information processing device 111.

The action plan evaluation unit 131 calculates the evaluation index for the action plan from each of the autonomous mobile bodies 21A and 21B. The action plans from the respective autonomous mobile bodies 21A and 21B and their calculated evaluation indexes are supplied from the action plan evaluation unit 131 to the arbitration unit 132.

In the arbitration unit 132, the autonomous mobile body to execute the action plan is selected from the autonomous mobile bodies 21A and 21B on the basis of the action plan from the action plan evaluation unit 131 and the evaluation index. In a case where the autonomous mobile body 21A is selected as the autonomous mobile body that executes the action plan, the action plan calculated by the autonomous mobile body 21A as illustrated in FIG. 11 is supplied from the arbitration unit 132 to the control unit 44 of the autonomous mobile body 21A. Thus, execution of the action plan is instructed to the autonomous mobile body 21A.

The control unit 44 calculates a control value for controlling the actuator 45 according to the action plan from the arbitration unit 132, and supplies the control value to the actuator 45.

The actuator 45 generates power according to the control value from the control unit 44 to cause the autonomous mobile body 21 to move or execute other actions.

Note that the operation of the sensor 46 and the recognition unit 47 of each of the autonomous mobile bodies 21A and 21B is the same as that in the case of FIG. 4, and thus the description thereof will be omitted.

(Processing Procedure of Autonomous Mobile Body Control System 101)

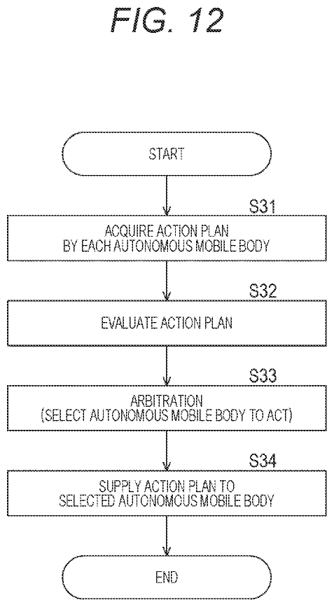

FIG. 12 is a flowchart illustrating a processing procedure performed by the information processing device 111 of the autonomous mobile body control system 101. Note that the processing procedure in each autonomous mobile body 21 is common to the case of FIG. 5. However, in the autonomous mobile body 21 of the present embodiment, processing in the information processing device 111 is interposed between step S17 and step S18 in FIG. 5, and processing in step S18 is different from the processing of the autonomous mobile body 21 in the first embodiment in that the processing is executed only in a case where an instruction to execute the action plan is given from the information processing device 111.

In step S31 of FIG. 12, the action plan evaluation unit 131 of the information processing device 111 acquires the action plan calculated by each autonomous mobile body 21. The processing proceeds from step S31 to step S32.

In step S32, the action plan evaluation unit 131 calculates the evaluation index of the action plan from each autonomous mobile body 21 acquired in step S31, and supplies each action plan and the calculated evaluation index to the arbitration unit 132. The processing proceeds from step S32 to step S33.

In step S33, the arbitration unit 132 selects the autonomous mobile body 21 to execute the action plan on the basis of the action plan of each autonomous mobile body 21 supplied in step S32 and its evaluation index. The processing proceeds from step S33 to step S34.

In step S34, the arbitration unit 132 supplies the action plan to the autonomous mobile body 21 selected in step S33, and instructs execution of the action plan.

Every time the user designates a new movement purpose and a new movement target, the processing from step S31 to step S34 described above is executed in the information processing device 111.

(Description of Effectiveness of Autonomous Mobile Body Control System 101)

According to the second embodiment of the autonomous mobile body control system, each autonomous mobile body 21 executes an action within the feasible range with respect to the action purpose and the action target designated by the user according to the capability of the host device, the state of the moving space, and the like.

Therefore, it is possible to designate the action purpose and the action target without depending on the capability of the autonomous mobile body 21, the state of the moving space, and the like.

Even in a case where it is impossible to completely achieve the designated action purpose and action target, it is possible to cause the autonomous mobile body 21 to execute a suitable action for the purpose within the feasible range, and it is possible to cause the autonomous mobile body 21 to flexibly cope with the action purpose and the action target.

According to the second embodiment of the autonomous mobile body control system, a plurality of autonomous mobile bodies 21 corresponds to one action purpose and one action target, and the autonomous mobile body 21 that executes the action corresponding to the action purpose is arbitrated (selected) on the basis of the action plan of each autonomous mobile body 21. Therefore, the feasibility of the action purpose is improved as compared with a case where one autonomous mobile body 21 copes with the action purpose.

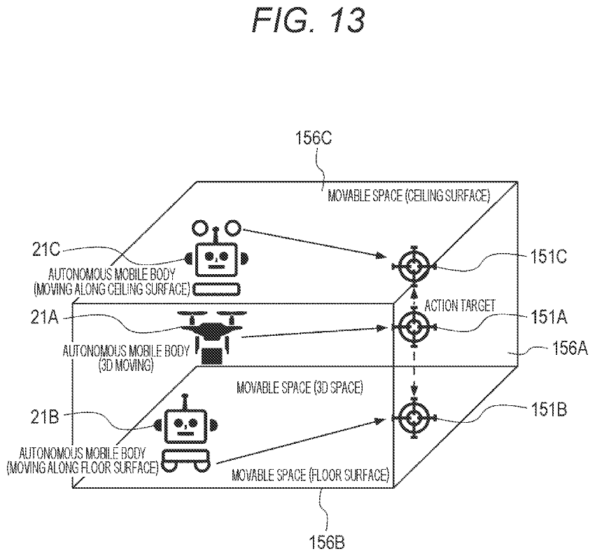

FIG. 13 is a diagram illustrating operations of the autonomous mobile bodies 21A, 21B, and 21C of the present embodiment with respect to an example of the action purpose and the action target.

In FIG. 13, the autonomous mobile body 21A moves in a range of a movable space 156A that is a three-dimensional space by, for example, a flying-type moving method.

The autonomous mobile body 21B moves in a range of a movable space 156B along a floor surface by, for example, the vehicle-type moving method.

The autonomous mobile body 21C moves in a range of a movable space 156C along a ceiling surface by, for example, the multileg type moving method.

FIG. 13 illustrates a case where the user designates movement as the action purpose, and designates a movement target 151A (target position) within the range of the movable space 156A and outside the ranges of the movable spaces 156B and 156C as the action target.

In this case, the autonomous mobile body 21A sets the movement target 92A as the reachable target and creates the action plan.

The autonomous mobile body 21B corrects the movement target 151A to a position within the range of the movable space 156B, sets the corrected position as the reachable target 151B, and creates the action plan.

The autonomous mobile body 21C corrects the movement target 151A to a position within the range of the movable space 156C, sets the corrected position as the reachable target 151C, and creates the action plan.

On the basis of the action plans of the autonomous mobile bodies 21A to 21C, the autonomous mobile body that executes the action corresponding to the action purpose is selected by the arbitration unit 132.

Therefore, it is possible to select one autonomous mobile body 21A suitable for achieving the action purpose and the action target and cause the autonomous mobile body 21A to execute the action plan, and it is possible to select one optimal autonomous mobile body in consideration of the energy consumption amount, safety, and the like and cause the autonomous mobile body to execute the action plan.

As in a case where the user designates the movement target 151A as a search point of the disaster site, for example, the user designates a plurality of autonomous mobile bodies 21 that execute the action corresponding to the action purpose, so that it is possible to cause two or all of the autonomous mobile bodies 21A to 21C to execute the action plan. A plurality of autonomous mobile bodies 21 may be allowed to designate the action purpose (for example, a disaster site search) for executing the action corresponding to the action purpose.

In this case, the plurality of autonomous mobile bodies 21 suitable for achieving the action purpose is arbitrated (selected) on the basis of the action plan of each autonomous mobile body 21. Therefore, the feasibility of the action purpose is improved as compared with a case where only one autonomous mobile body 21 copes with the action purpose. Even in a case where a trouble occurs in any of the autonomous mobile bodies 21, any of the other autonomous mobile bodies 21 can achieve the action purpose, so that the feasibility of the action purpose is improved as compared with a case where only one autonomous mobile body 21 copes with the action purpose.

<Program>

Part or all of the series of processes in the autonomous mobile body control systems 11 and 101 described above can be executed by hardware or software. In a case where the series of processes is executed by software, a program constituting the software is installed in a computer. Here, the computer includes a computer incorporated in dedicated hardware, a general-purpose personal computer for example that can execute various functions by installing various programs, and the like.

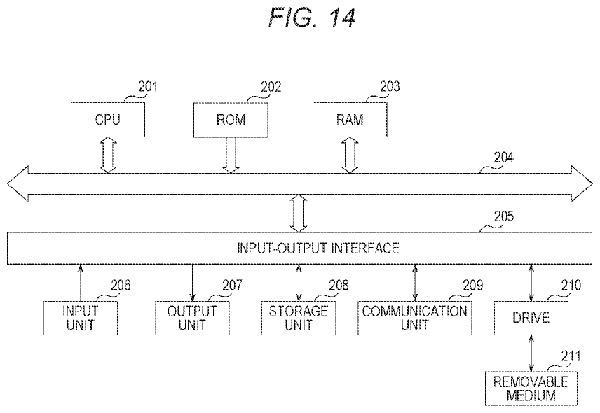

FIG. 14 is a block diagram illustrating a configuration example of hardware of a computer that executes the above-described series of processing by a program.

In the computer, a central processing unit (CPU) 201, a read only memory (ROM) 202, and a random access memory (RAM) 203 are mutually connected by a bus 204.

An input-output interface 205 is further connected to the bus 204. An input unit 206, an output unit 207, a storage unit 208, a communication unit 209, and a drive 210 are connected to the input-output interface 205.

The input unit 206 includes a keyboard, a mouse, a microphone, and the like. The output unit 207 includes a display, a speaker, and the like. The storage unit 208 includes a hard disk, a nonvolatile memory, and the like. The communication unit 209 includes a network interface and the like. The drive 210 drives a removable medium 211 such as a magnetic disk, an optical disk, a magneto-optical disk, or a semiconductor memory.

In the computer configured as described above, for example, the CPU 201 loads the program stored in the storage unit 208 into the RAM 203 via the input-output interface 205 and the bus 204 and executes the program, to thereby perform the above-described series of processes.

The program executed by the computer (CPU 201) can be provided by being recorded in the removable medium 211 as a package medium or the like, for example. Furthermore, the program can be provided via a wired or wireless transmission medium such as a local area network, the Internet, or digital satellite broadcasting.

In the computer, the program can be installed in the storage unit 208 via the input-output interface 205 by mounting the removable medium 211 to the drive 210. Furthermore, the program can be received by the communication unit 209 via a wired or wireless transmission medium and installed in the storage unit 208. In addition, the program can be installed in the ROM 202 or the storage unit 208 in advance.

Note that the program executed by the computer may be a program for processing in time series in the order described in the present description, or a program for processing in parallel or at a necessary timing such as when a call is made.

The present technology can have configurations as follows.

(1) An information processing device, including

a target planning unit that calculates a movement target of a mobile device on the basis of action target information indicating an action target that designates a movement destination of the mobile device and movable space information indicating a movable space that is a range of a real space in which the mobile device is movable.

(2) The information processing device according to (1) above, in which

the target planning unit

calculates a temporary movement target representing the movement destination of the mobile device on the basis of the action target information, and calculates the movement target on the basis of the temporary movement target and the movable space information.

(3) The information processing device according to (2) above, in which

the target planning unit

determines feasibility of movement of the mobile device to the temporary movement target on the basis of the movable space information.

(4) The information processing device according to (2) or (3) above, in which

the target planning unit

calculates the movement target for which the feasibility is higher than the feasibility for the temporary movement target.

(5) The information processing device according to (4) above, in which

the target planning unit

calculates, in a case where the temporary movement target is out of a range of the movable space, the movement target within the range of the movable space.

(6) The information processing device according to (5) above, in which

the target planning unit

calculates the movement target closest to the temporary movement target.

(7) The information processing device according to any one of (4) to (6) above, in which

the target planning unit

calculates the movement target within a range of the movable space on the basis of action purpose information indicating an action purpose of the mobile device.

(8) The information processing device according to any one of (1) to (7) above, in which

the action target information includes information of any one or more of a target position, a target posture, a target region, and a target object.

(9) The information processing device according to (7) above, in which

the action purpose information includes information of any one or more of movement, approach, and image-capturing.

(10) The information processing device according to (7) or (8) above, in which

the action target information is information corresponding to the action purpose information.

(11) The information processing device according to (10) above, in which

the target planning unit

calculates, in a case where the action purpose indicated by the action purpose information is movement, the movement target by using any one or more of a target position, a target posture, and a target region as the action target information.

(12) The information processing device according to (10) or (11) above, in which

the target planning unit

calculates, in a case where the action purpose indicated by the action purpose information is approach, the movement target by using information of a target object of the approach as the action target information.

(13) The information processing device according to any one of (7) and (9) to (12) above, in which

the target planning unit

calculates, in a case where the action purpose indicated by the action purpose information is image-capturing, the movement target by using information of a target object of the image-capturing as the action target information.

(14) The information processing device according to any one of (7) and (9) to (13) above, in which

the mobile device includes a plurality of mobile devices, and

the information processing device further includes an arbitration unit that selects one or more mobile devices among the plurality of mobile devices as the mobile device that executes the action purpose on the basis of the action purpose information.

(15) The information processing device according to (14) or (15) above, in which

the arbitration unit

selects one or more mobile devices among the plurality of mobile devices as mobile devices that execute the action purpose on the basis of an evaluation index for evaluating superiority and inferiority in a case where the action purpose indicated by the action purpose information is executed.

(16) The information processing device according to (14) or (15) above, in which

the arbitration unit

selects one or more mobile devices among the plurality of mobile devices as mobile devices that execute the action purpose on the basis of an evaluation index for evaluating superiority and inferiority in a case where each of the plurality of mobile devices executes movement to the movement target calculated by the target planning unit.

(17) The information processing device according to any one of (1) to (16) above, in which

the mobile device includes any one of a vehicle type, a flying type, a multileg type, and an infinite track type mobile device.

(18) An information processing method including, by a target planning unit of an information processing device that includes the target planning unit,

calculating a movement target of a mobile device on the basis of action target information indicating an action target that designates a movement destination of the mobile device and movable space information indicating a movable space that is a range of a real space in which the mobile device is movable.

(19) A program for causing a computer to function as

a target planning unit that calculates a movement target of a mobile device on the basis of action target information indicating an action target that designates a movement destination of the mobile device and movable space information indicating a movable space that is a range of a real space in which the mobile device is movable.

### REFERENCE SIGNS LIST

11, 111 Autonomous mobile body control system
21 Autonomous mobile body
22 Operation device
41 Transmission-reception unit
42 Target planning unit
43 Action planning unit
44 Control unit
45 Actuator
46 Sensor
47 Recognition unit
48 Storage unit
61 Movement target calculation unit
62 Feasibility determination unit
63 Movement target recalculation unit

1. An information processing device, comprising
a target planning unit that calculates a movement target of a mobile device on a basis of action target information indicating an action target that designates a movement destination of the mobile device and movable space information indicating a movable space that is a range of a real space in which the mobile device is movable.

2. The information processing device according to claim 1, wherein
the target planning unit
calculates a temporary movement target representing the movement destination of the mobile device on a basis of the action target information, and calculates the movement target on a basis of the temporary movement target and the movable space information.

3. the information processing device according to claim 2, wherein
the target planning unit
determines feasibility of movement of the mobile device to the temporary movement target on a basis of the movable space information.

4. The information processing device according to claim 3, wherein
the target planning unit
calculates the movement target for which the feasibility is higher than the feasibility for the temporary movement target.

5. The information processing device according to claim 4, wherein
the target planning unit
calculates, in a case where the temporary movement target is out of a range of the movable space, the movement target within the range of the movable space.

6. The information processing device according to claim 5, wherein
the target planning unit
calculates the movement target closest to the temporary movement target.

7. The information processing device according to claim 4, wherein
the target planning unit
calculates the movement target within a range of the movable space on a basis of action purpose information indicating an action purpose of the mobile device.

8. The information processing device according to claim 1, wherein
the action target information includes information of any one or more of a target position, a target posture, a target region, and a target object.

9. The information processing device according to claim 7, wherein
the action purpose information includes information of any one or more of movement, approach, and image-capturing.

10. The information processing device according to claim 7, wherein
the action target information is information corresponding to the action purpose information.

11. The information processing device according to claim 7, wherein
the target planning unit
calculates, in a case where the action purpose indicated by the action purpose information is movement, the movement target by using any one or more of a target position, a target posture, and a target region as the action target information.

12. The information processing device according to claim 7, wherein
the target planning unit
calculates, in a case where the action purpose indicated by the action purpose information is approach, the movement target by using information of a target object of the approach as the action target information.

13. The information processing device according to claim 7, wherein
the target planning unit
calculates, in a case where the action purpose indicated by the action purpose information is image-capturing, the movement target by using information of a target object of the image-capturing as the action target information.

14. The information processing device according to claim 7, wherein
the mobile device includes a plurality of mobile devices, and
the information processing device further comprises an arbitration unit that selects one or more mobile devices among the plurality of mobile devices as the mobile device that executes the action purpose on a basis of the action purpose information.

15. The information processing device according to claim 14, wherein
the arbitration unit
selects one or more mobile devices among the plurality of mobile devices as mobile devices that execute the action purpose on a basis of an evaluation index for evaluating superiority and inferiority in a case where the action purpose indicated by the action purpose information is executed.

16. The information processing device according to claim 14, wherein
the arbitration unit
selects one or more mobile devices among the plurality of mobile devices as mobile devices that execute the action purpose on a basis of an evaluation index for evaluating superiority and inferiority in a case where each of the plurality of mobile devices executes movement to the movement target calculated by the target planning unit.

17. The information processing device according to claim 1, wherein
the mobile device includes any one of a vehicle type, a flying type, a multileg type, and an infinite track type mobile device.

18. An information processing method comprising, by a target planning unit of an information processing device that includes the target planning unit,
calculating a movement target of a mobile device on a basis of action target information indicating an action target that designates a movement destination of the mobile device and movable space information indicating a movable space that is a range of a real space in which the mobile device is movable.

19. A program for causing a computer to function as
a target planning unit that calculates a movement target of a mobile device on a basis of action target information indicating an action target that designates a movement destination of the mobile device and movable space information indicating a movable space that is a range of a real space in which the mobile device is movable.
